(19) United States
(12) Patent Application Publication
(10) Pub. No.: US 2018/0294970 A1
(43) Pub. Date: Oct. 11, 2018

(54) METHODS OF AFFILIATION, EMANCIPATION AND VERIFICATION BETWEEN A TUTOR AND TUTEE

(71) Applicant: IDEMIA FRANCE, Colombes (FR)

(72) Inventors: Cédric BARREAU, Colombes (FR); Alban FERAUD, Colombes (FR)

(21) Appl. No.: 15/738,556

(22) PCT Filed: Jun. 21, 2016
(86) PCT No.: PCT/FR2016/051511

§ 371 Date: Jun. 11, 2018

(30) Foreign Application Priority Data
Jun. 22, 2015 (FR) 1555719

(51) Int. Cl. H04L 9/32; G06Q 50/20

(52) U.S. Cl. CPC H04L 9/3247; G06Q 2220/00; G06Q 50/205

(57) ABSTRACT

An affiliation method for identifying a tutoring relationship between a tutor and a tutee. The affiliation method includes the following steps: creating an affiliation attestation that includes a tutor authorization comprising the rights over the tutee that are allocated to the tutor, and storing the affiliation attestation. There is also a related emancipation method, as well as corresponding verification methods.

The present invention relates to defining and enforcing relationships that may exist between a tutor and a tutee, advantageously in secure manner.

In the present specification, the term “tutee” is used to mean a person not entitled to perform some formality on their own. Performing such a formality requires the oversight of a tutor. In the present specification, the term “tutor” means a person holding rights for the tutee and capable of performing such a formality in the name of the tutee or of authorizing the tutee to perform such a formality. So far as we are aware, when such a formality involves a tutee, there do not exist at present any means enabling the formality to be performed while taking account of the particular situation of the tutee, of the tutee's limited rights, and where appropriate, of the necessary intervention of the tutor.

The present invention remedies those various drawbacks and proposes establishing an affiliation defining a relationship, between a tutee and a tutor, indicating a tutoring relationship. The present invention further makes provision for performing emancipation that enables the rights of the tutor to be transferred to the tutee. Corresponding verification methods are also proposed.

The invention provides an affiliation method identifying a tutoring relationship between a tutor and a tutee, the affiliation method comprising the following steps: creating an affiliation attestation comprising: a tutor authorization comprising the rights over the tutee that are allocated to the tutor, and storing the affiliation attestation.

According to another characteristic, the method further comprises a step of producing an electronic guarantee of the integrity and the authenticity of the affiliation attestation.

According to another characteristic, the electronic guarantee is an affiliation seal produced by electronically signing the affiliation attestation by means of authority cryptographic material associated with an authority, and the method further comprises a following step of storing the affiliation seal.

According to another characteristic, the authority cryptographic material comprises an authority public key and an authority private key, and the portion of the authority cryptographic material used for producing the affiliation seal comprises the authority private key.

According to another characteristic, the affiliation attestation further comprises a tutor attribute and/or a tutee attribute.

According to another characteristic, the tutor is associated with tutor cryptographic material, and the tutor attribute comprises at least a portion of the tutor cryptographic material, and/or the tutee is associated with tutee cryptographic material, and the tutee attribute comprises at least a portion of the tutee cryptographic material.

According to another characteristic, the tutor cryptographic material comprises a tutor public key and a tutor private key, and the portion of the tutor cryptographic material comprised in the tutor attribute comprises the tutor public key, and/or the tutee cryptographic material comprises the tutee public key and a tutee private key, and the portion of the tutee cryptographic material comprised in the tutee attribute comprises the tutee public key.

According to another characteristic, the storage step(s) is/are performed: on a tutor document associated with the tutor, on a tutee document associated with the tutee, on a mass storage medium, on a network storage medium, or indeed distributed over a plurality of the above media.

According to another characteristic, the tutor document and the tutee document are electronic documents produced by the authority, the tutor electronic document storing the tutor cryptographic material, and the tutee electronic document storing the tutee cryptographic material.

The invention also provides a verification method for verifying an affiliation made by the affiliation method, the verification method comprising the following steps: reading the affiliation attestation, optionally checking the origin and the integrity of the affiliation attestation by verifying the electronic guarantee, and making use of the tutor authorization.

According to another characteristic, the checking of the origin and the integrity of the affiliation attestation further comprise the steps of reading the affiliation seal, and of checking the affiliation seal by means of at least a portion of the authority cryptographic material.

According to another characteristic, the authority cryptographic material comprises an authority public key and an authority private key, and the portion of the authority cryptographic material used for checking the affiliation seal comprises the authority public key.

According to another characteristic, the verification method further comprises at least one of the following steps: if a tutor attribute is comprised in the affiliation attestation, optionally checking the authenticity of the tutor by proving that the tutor knows the tutor attribute comprised in the affiliation attestation, and if a tutee attribute is comprised in the affiliation attestation, optionally checking the authenticity of the tutee by proving that the tutee knows the tutee attribute.

According to another characteristic, the verification further comprises at least one of the following steps: if a portion of the tutor cryptographic material is comprised in the affiliation attestation, optionally checking the authenticity of the tutor document by proving that it holds at least a portion of the tutor cryptographic material, and if a portion of the tutee cryptographic material is comprised in the affiliation attestation, optionally checking the authenticity of the tutee document by proving that it holds at least a portion of the tutee cryptographic material.

According to another characteristic, the verification method further comprises at least one of the following steps: if the tutor cryptographic material comprises a tutor public key and a tutor private key, optionally checking the authenticity of the tutor electronic document by proving that it holds the tutor private key by using a challenge and response with the tutor public key if said tutor public key is comprised in the affiliation attestation, and if the tutee cryptographic material comprises a tutee public key and a tutee private key, optionally checking the authenticity of the tutee electronic document by proving that it holds the tutee private key by using a challenge and response with the tutee public key if said tutee public key is comprised in the affiliation attestation.

The invention also provides an emancipation method enabling a tutor to emancipate a tutee, the emancipation method comprising the following steps: creating an emancipation attestation comprising: a tutee authorization comprising the rights emancipated to the tutee by the tutor, storing the emancipation attestation, and if it is not already present, storing the affiliation attestation produced by the affiliation method.

According to another characteristic, the emancipation method further comprises a step of producing an electronic guarantee of the integrity and the authenticity of the emancipation attestation.

According to another characteristic, the electronic guarantee is an emancipation seal produced by electronically signing the emancipation attestation by means of tutor cryptographic material, and the method further comprises a step of storing the emancipation seal.

According to another characteristic, the emancipation attestation further comprises a tutor attribute and/or a tutee attribute.

According to another characteristic, the tutor is associated with tutor cryptographic material, and the tutor attribute comprises at least a portion of the tutor cryptographic material, and/or the tutee is associated with tutee cryptographic material, and the tutee attribute comprises at least a portion of the tutee cryptographic material.

According to another characteristic, the tutor cryptographic material comprises a tutor public key and a tutor private key, and the portion of the tutor cryptographic material used for producing the emancipation seal comprises the tutor private key.

According to another characteristic, the tutor cryptographic material comprises a tutor public key and a tutor private key, and the portion of the tutor cryptographic material comprised in the tutor attribute comprises the tutor public key, and/or the tutee cryptographic material comprises a tutee public key and the tutee private key, and the portion of the tutee cryptographic material comprised in the tutee attribute comprises the tutee public key.

According to another characteristic, the electronic signing step is conditional on supplying a tutor document and on authenticating the bearer of the tutor document, by means of a PIN code associated with the tutor document, and/or a biometric identification, and/or by proving that the bearer knows a tutor attribute comprised in the affiliation attestation or in the emancipation attestation.

According to another characteristic, the storage step(s) is/are performed: on a tutor document associated with the tutor, on a tutee document associated with the tutee, on a mass storage medium, on a network storage medium, or indeed distributed over a plurality of the above media.

According to another characteristic, the tutor document and the tutee document are electronic documents produced by an authority, the tutor electronic document stores the tutor cryptographic material, and the tutee electronic document stores the tutee cryptographic material.

The invention also provides a verification method for verifying an emancipation performed by the emancipation method, the verification method comprising the following steps: reading the affiliation attestation, optionally checking the origin and the integrity of the affiliation attestation by verifying the associated electronic guarantee, reading the emancipation attestation, optionally checking the origin and the integrity of the emancipation attestation by verifying the associated electronic guarantee, and making use of the tutee authorization.

According to another characteristic, the checking of the origin and the integrity of the affiliation attestation further comprises the following steps: reading the affiliation seal, checking the affiliation seal by means of at least a portion of the authority cryptographic material, and the checking of the origin and the integrity of the emancipation attestation further comprises the following steps: extracting at least a portion of the tutor cryptographic material from the affiliation attestation, reading the emancipation attestation, reading the emancipation seal, and checking the emancipation seal by means of at least a portion of the tutor cryptographic material.

According to another characteristic, the authority cryptographic material comprises an authority public key and an authority private key, the portion of the authority cryptographic material used for verifying the affiliation seal comprises the authority public key, and the tutor cryptographic material comprises a tutor public key and a tutor private key, the portion of the tutor cryptographic material used for checking the emancipation seal comprises the tutor public key.

According to another characteristic, the verification method further comprises a step of: if a tutee attribute is comprised in the affiliation attestation or in the emancipation attestation, optionally checking the authenticity of the tutee by proving that the tutee knows said tutee attribute.

According to another characteristic, the verification method further comprises a step of: if a portion of the tutee cryptographic material is comprised in the affiliation attestation or in the emancipation attestation, optionally controlling the authenticity of the tutee document by proving that it holds at least a portion of the tutee cryptographic material.

According to another characteristic, the verification method further comprises a step of: if the tutee cryptographic material comprises a tutee public key and a tutee private key, and if said tutee public key is comprised in the affiliation attestation or in the emancipation attestation, optionally checking the authenticity of the tutee electronic document by proving that it holds the tutee private key, by means of a challenge and response with said tutee public key.

The invention also provides an electronic document comprising an affiliation attestation and/or an electronic guarantee, and/or an emancipation attestation and/or an electronic guarantee.

According to another characteristic, the electronic document comprises a tutor attribute or a tutee attribute, in order to form respectively a tutor electronic document and/or a tutee electronic document.

Other characteristics, details, and advantages of the invention appear more clearly from the detailed description given below by way of indication with reference to the drawings, in which:

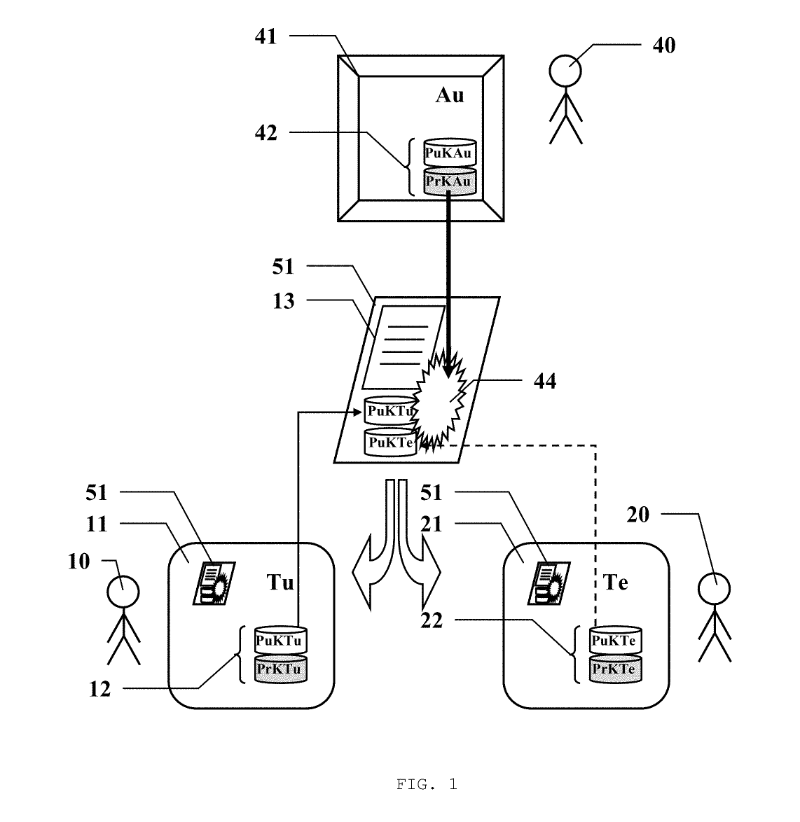

FIG. 1 shows an affiliation between a tutor electronic document and a tutee electronic document; and

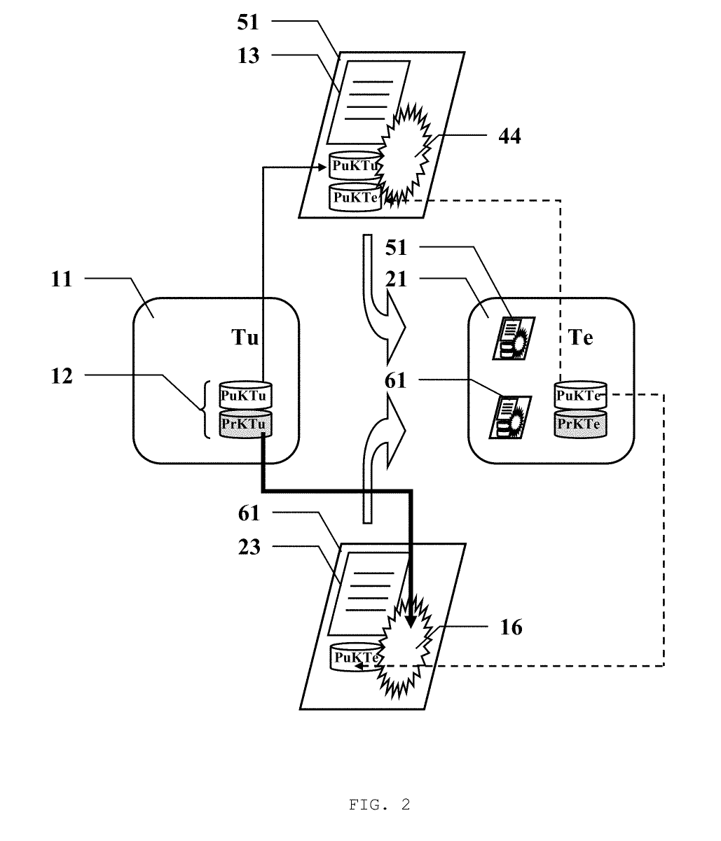

FIG. 2 shows an emancipation benefiting from a tutee electronic document, performed by a tutor electronic document.

It is appropriate to specify the definitions of the terms used in the present specification.

The tutee is a person, having limited particular rights in that the person cannot perform on their own certain formalities, but can perform them under the oversight of a tutor. By way of example, the tutee is a person presenting limited legal capacity. The person may be a minor, a person under guardianship, or a person under curatorship. By way of example, the tutee may be a subordinate having accesses/authorizations/rights over a system that are defined under the oversight of a hierarchical superior. The term “tutee” should be understood in the present specification as covering any of these terms equally well.

By extension, the term “tutee” is used in the present specification for qualifying elements associated with the tutee person. This applies to a tutee document, to a tutee electronic document, to a tutee cryptographic pair, or indeed to a tutee public/private key.

The tutor is a person having authority over the tutee for allowing the tutee, under the oversight of the tutor, to perform operations that the tutee cannot perform alone. By way of example, the tutor may be a person having the capacity to represent the tutee in the legal sense. The person may be a parent or a tutor of a minor, a guardian of a person under guardianship, or indeed a curator for a person under curatorship. By way of example, the tutor may be a hierarchical superior. The term “tutor” in the present specification is used to cover any of these terms equally well.

By extension, the term “tutor” is used in the present specification to qualify elements associated with the person of the tutor. This may apply to a tutor document, to a tutor electronic document, to a tutor cryptographic pair, or indeed to a tutor public/private key.

A document is a medium suitable for storing information. It may be a sheet of paper, a card, a booklet, a plastics card, a badge, a magnetic strip, suitable for receiving an inscription that may be written, drawn, printed, etched, embossed, visible or hidden, a bar code, a QR code, etc. . . . . A document is advantageously issued by an authority. In order to guarantee its origin, its authenticity, its provenance, and its integrity, a document advantageously comprises an authentication and/or security device: a stamp, a certification, a hologram, or any means allowing the issuing authority to provide a signature in order to guarantee origin and integrity.

One particular type of document is an electronic document. An electronic document 11, 21 comprises information storage means, such as a memory, that is made secure by a microcircuit or chip. Its form may vary and comprise a microcircuit card such as a bank card or a SIM card, a USB key, a mobile telephone, a memory card, such as an SD card, an RFID tag, etc. An electronic document thus comprises a storage zone that is accessible only by means of dialog with the microcircuit, which may apply any type of access control to the stored data. An electronic document 11, 21 is thus suitable for storing cryptographic material. The microcircuit gives the electronic document the ability to process, enabling calculations to be performed, comparisons to be made, and indeed tests of consistency or authenticity to be undertaken, or else enabling encryption to be performed or an electronic signature to be provided.

Such an electronic document 11, 21, may be used as a telephone card, a social security card, a bank card, a driver's license, an identity document such as an electronic identity card, or a travel document, such as an electronic passport. Such an electronic document is usually associated with a person or carrier, enabling that person to transport personal data in secure manner, typically relying on cryptographic and/or biometric material. The data and the material may enable the bearer of the electronic document to state their rights.

Thus, an identity document enables a person to prove their identity by indicating their civil status with certainty. A social security card may contain a person's medical dossier together with that person's insurance rights. A bank card may enable a person to perform operations, payments, withdrawals, etc. on one or more bank accounts. A travel document may enable a person to prove their identity and allow that person to travel by making it possible to perform inspection formalities on crossing a frontier.

In the present description, several parties 10, 20, 40 hold cryptographic material 12, 22, 42, e.g. comprising respective cryptographic pairs 12, 22, 42. A cryptographic pair is personal and associated with one of the parties (authority, tutor, tutee, . . . ) and is stored in secure manner, e.g. in an electronic document associated with the party. In known manner, the cryptographic pair comprises asymmetric cryptographic material with a public key PuKxx and a private key PrKxx that are associated with each other, where xx is a code designating the party: Au=authority, Tu=tutor, Te=tutee. By way of example, such a cryptographic pair 12, 22, 42 may be of any of the following types: RSA, two keys on elliptic curves, ECC, or the equivalent.

Such a cryptographic pair 12, 22, 42 makes several kinds of processing possible. A basic property is that a signature made by means of the private key PrKxx can be verified by means of the associated public key PuKxx, but without that revealing the private key PrKxx, nor enabling it to be deduced. The public key PuKxx may be distributed to recipients, who are then in a position to use the public key PuKxx to verify a signature made using the private key PrKxx, but without that giving them the ability to make such a signature.

An electronic document serves advantageously to store a private key PrKxx, and to sign it by means of the private key, without disclosing or externalizing said private key PrKxx, which remains specific to its holder and under the exclusive control of its holder.

This enables a party to be authenticated, by proving that said party is in possession of a private key PrKxx specific to that party, but without disclosing the private key PrKxx. This is typically performed by means of an exchange referred to as a challenge and response. An inspector, in possession of the public key PuKxx of a person, challenges a claimant by submitting random test data. The claimant signs the test data by using the private key PrKxx and returns the signed data to the inspector. The inspector verifies the returned signed data by means of the public key PuKxx. If the received signature and the initial test data match, in that using the associated public key on the received signature produces data that can be correctly verified with the test data, then the claimant does indeed possess the private key PrKxx and can reasonably be taken to be the person in question. This serves to authenticate a person.

It is also possible to use such a cryptographic pair 12, 22, 42 for electronically signing data by making a seal 16, 44 serving to ensure the integrity of the transmitted data. Under such circumstances, an issuer transmits data and accompanies that data with an electronic seal 16, 44 made by using the issuer's private key PrKxx to sign at least a portion or a digest of the data. The receiver, who has the issuer's public key PuKxx, verifies the seal by means of said public key PuKxx and compares the result with the portion or digest of the data. If they are identical, then the seal was indeed made using the private key PrK associated with the public key PuK, thus attesting that the data does indeed have the issuer as its origin and also attesting the integrity of the data, which cannot have been modified since it was signed.

All of the cryptographic pairs used by the invention are preexisting. Thus an important advantage of the invention is that it does not need new cryptographic material.

Following these general considerations, there follows a description of two methods that enable a tutoring relationship tutor to be identified and managed. Each of these methods is also associated with a respective verification method.

The first need relates to defining the tutoring relationships associating a tutor 10 with a tutee 20, and the associated rights, in order to identify said tutoring relationship.

For this purpose, an affiliation is established between a tutor 10 and a tutee 20 by means of an affiliation method. Such an affiliation is identified by an affiliation attestation 51 that comprises at least a tutor authorization 13 with a list of the rights allocated to the tutor 10 over the tutee. Such an affiliation attestation 51 may comprise any durable medium or recording means. It may be a handwritten or printed letter, a microfilm, a sound recording listing said rights. After being created, such an affiliation attestation 51 is recorder or stored so as to be capable of being consulted subsequently in order to be used and allow a tutor or a tutee to assert at least one of their rights.

In an advantageous implementation, an affiliation attestation is advantageously digital in order to enable it to be stored and processed by computer.

In order to make an affiliation attestation 51 secure, a guarantee of integrity and authenticity is advantageously produced. Such a guarantee is advantageously affixed or associated with the affiliation attestation 51 in that it resumes at least an element of the affiliation attestation 51 in order to be connected therewith. Such a guarantee is advantageously difficult to reproduce and capable of withstanding any modification in order to constitute a guarantee that is reliable. In addition, the guarantee is advantageously provided by the authority 40 that issues the affiliation attestation 51 in order to authenticate the origin of the affiliation attestation 51 and its integrity.

Such a guarantee may take various forms, from the very simple to the very complex, depending on the desired level of security. Thus, a guarantee may be a write access right held by the authority 40 over the medium or a portion of the medium in which the affiliation attestation is stored. Sharing write access with an organization performing verification can serve to guarantee the authenticity and the integrity of the affiliation attestation 51. A guarantee may also be any security device suitable for being inspected by a verifying organization. By way of example, an electronic guarantee of integrity may be a checksum. Other implementations of such a guarantee and the associated verification techniques are possible and limited only by the imagination of the person skilled in the art.

It is advantageously possible to use said guarantee in order to verify it and thus confirm the authenticity and the integrity of the affiliation attestation 51.

In a preferred implementation, the guarantee is electronic.

In another preferred implementation, the electronic guarantee is an affiliation seal 44 produced by electronically signing the affiliation attestation 51 using authority cryptographic material 42 associated with an authority 40. The authority 40 may be a trusted third party, and in particular circumstances, the authority 40 may issue the affiliation attestation 51.

After producing such an affiliation seal 44 by electronic signature, the affiliation seal 44 is advantageously stored. It can be stored in any location, together with or separately from the affiliation attestation 51. In one particular implementation, it may be incorporated in the affiliation attestation 51. The only constraint is that said affiliation seal 44 can be reread whenever necessary, e.g. in order to verify the affiliation attestation 51.

According to a characteristic, the affiliation attestation 51 also comprises a tutor attribute and/or a tutee attribute. The term “attribute” is used herein to mean an element, recording, piece of data, a possession, etc., relating to or associated with the respective tutor and/or tutee in person and serving to establish a link with that person. By way of example, it may be that person's name, social security number, identity photograph, preferred color, a PIN code, biometric data, cryptographic means, etc.

In an implementation, the tutor 10 is associated with tutor cryptographic material 12. Under such circumstances, the tutor attribute may be made up of at least a portion of the tutor cryptographic material 12. Likewise, the tutee 20 may be associated with tutee cryptographic material 22. Under such circumstances, the tutee attribute comprises at least a portion of the tutee cryptographic material 22.

As mentioned above, the affiliation attestation 51 and an affiliation seal 44, if any, are capable of being stored. The storage may be performed on any medium, so long as it is capable of being reread for subsequent use. Thus, the storage may be performed on a tutor document 11 associated with the tutor 10, on a tutee document 21 associated with the tutee 20, and more generally on any mass storage medium, such as a local hard disk, a memory card, a USB key, a microcircuit card, a telephone, etc., or indeed on such a mass storage medium that is accessible by a communications network, and referred to as a “network storage” medium. Each of the stored elements may be stored in full on only one of the media, or it may be divided into a plurality of portions, each portion being stored on a storage medium selected from amongst the above-mentioned media.

In a preferred implementation, the tutor 10 is associated with a tutor electronic document 11 and the tutee 20 is associated with a tutee electronic document 21. Under such circumstances, and as shown in FIG. 1, an affiliation is established in electronic manner between the tutor 10 represented by the tutor electronic document 11 and the tutee 20 represented by the tutee electronic document 21, by performing an affiliation method.

The tutor cryptographic material comprises a tutor cryptographic pair 12 comprising a tutor public key PuKTu and a tutor private key PrKTu. The tutee cryptographic material comprises a tutee cryptographic pair 22 comprising a tutee public key PuKTe and a tutee private key PrKTe. The tutor cryptographic pair 12 and the tutee cryptographic pair 22 are typically stored respectively on the tutor electronic document 11 and on the tutee electronic document 21.

The tutor and tutee electronic documents 11 and 21 are produced by an authority 40. The authority 40 has authority cryptographic material 42 comprising an authority cryptographic pair 42 comprising an authority public key PuKAu and an authority private key PrKAu. This authority cryptographic pair 42 is typically stored in a highly secure “super” electronic document 41, also referred to as a hardware security module (HSM) serving as a cryptographic safe. The entire security of the system of the invention relies on keeping secret the authority cryptographic material, and in particular the authority private key PrKAu.

The term “authority” 40 is used herein to designate the organization in charge of issuing electronic documents 11, 21. Thus, for a travel document, the authority is typically a government, or in practice an industrial document signer (DS) working on behalf of and under the control of the government and to which the government subcontracts the technicalities of fabricating electronic documents.

As in the above-described general situation, the affiliation method comprises a first step of creating an affiliation attestation 51. This affiliation attestation, which identifies the tutoring relationship, comprises a tutor authorization 13. It may also comprise a tutor attribute, e.g. in the form of the tutor public key PuKTu. The tutor authorization 13 is a file containing the rights of the tutor 10 over the tutee 20. This tutor authorization 13 defines the tutor(s), the tutee(s), and the rights of the tutor over the tutee: what the tutor may do for and/or on behalf of the tutee, what the tutor 10 may authorize the tutee 20 with or without the presence of the tutor 10, what the tutor 10 may potentially delegate to a third party, any conditions on exercising these rights and any limits of these rights, whether in space or in time.

The definition of these rights is linked to the application. Thus, in a system for accessing a secure database, the rights may comprise the zones that are accessible or not accessible to the tutee 20 via the electronic document if any, and the kinds of access: read only, write, delete, and possible changes to those zones and kinds of access that the tutor 10 may authorize. Concerning a travel document for a child who is a minor (tutee), the rights of the parent (tutor) are defined by law and may possibly be changed by legal judgment.

During a second step, the entire content of the affiliation attestation 51 is subjected to an electronic signature by applying the authority private key PrKAu to at least a portion or digest coming from each of its constituent parts. This produces an affiliation seal 44 guaranteeing the origin (the authority) and the integrity of the affiliation attestation 51.

During a third step, the affiliation attestation 51 and the affiliation seal 44 are stored, together or separately, e.g. in the tutor electronic document 11, in the tutee electronic document 21, or in both of them.

In an implementation, it is also possible to store the affiliation attestation 51 and the affiliation seal 44 in part in the tutor electronic document 11 and in part in the tutee electronic document 21. Under such circumstances, recovering these two elements, e.g. for verification purposes, requires both the tutor electronic document 11 and the tutee electronic document 21. This is applicable when a formality that requires the affiliation attestation 51 and the affiliation seal 44 also requires the joint presence of the tutor electronic document 11 and of the tutee electronic document 21.

In another implementation, the affiliation attestation 51 and/or the affiliation seal 44 may also be stored, where appropriate in part, in at least one other medium. Advantageously, if it is necessary to read one or the other, it is appropriate that said medium can be present or at least remotely accessible in order to enable said reading.

FIG. 1 shows an implementation of the affiliation method. An affiliation attestation 51 is created that comprises a tutor authorization 13 containing the rights of the tutor 10. The tutor electronic document 11 always (as indicated by a continuous line) supplies (as indicated by a thin arrow) the tutor public key PuKTu. The tutee electronic document 21 optionally (as indicated by a dashed line) supplies (as indicated by a thin arrow) the tutee public key PuKTe. The authority electronic safe 41 signs (as indicated by a thick arrow) the affiliation attestation 51 by means of the authority private key PrKAu and produces an affiliation seal 44. The signed affiliation attestation 51 and the affiliation seal 44 are stored (as indicated by a broad white arrow), e.g. in the tutee electronic document 21 and/or in the tutor electronic document 11.

The tutor public key PuKTu is useful for performing verification operations, as described below. In this context, the tutor public key PuKTu is comprised in the affiliation attestation 51.

For another function, as described below, of verifying the authenticity of the tutee electronic document 21 or of the tutor electronic document 11, it may be useful to have the tutee public key PuKTe or the tutor public key PuKTu as the case may be. Thus, optionally, the affiliation attestation 51 may also comprise the tutee public key PuKTe.

The affiliation attestation 51 is the highest level attestation, from which most of the other operations depend. It is signed by the authority 40, which can be done only by the authority, and it requires the presence of the electronic document(s) 11, 21 or of the medium(a) on which the affiliation attestation 51 is stored.

Thus, in an advantageous implementation, during the initial issuing, the affiliation method is performed at the same time as producing the electronic document 11, 21 on which the affiliation attestation 51 is stored. This serves advantageously to limit the number of round trips between the electronic document 11, 21 and the authority 40.

With a travel document this is not very inconvenient. Most parent/child affiliations are defined initially and permanently. During a modification to an affiliation, it is always possible, as a result of a tutorship or curatorship being created or following an amending legal decision (amending guardianship conditions) to return an electronic document 11, 21 to the authority 40 in order to update the affiliation attestation 51.

It may be observed that a minor reaching majority, by reaching the legal age, does not necessarily require an affiliation attestation 51 to be modified. An age condition may typically be comprised in the time limit for the tutor authorization 13, causing all or part of the tutor authorization 13 contained in the affiliation attestation 51 to expire automatically at the majority of the minor.

Once created, an affiliation may be verified, typically prior to performing a formality.

A verification method depends on the form and the content of the affiliation. Thus, an affiliation that does not comprise any associated guarantee is difficult to verify other than by inspecting its appearance.

An affiliation that comprises a guarantee, which may be electronic or otherwise, can be verified. The way in which verification is performed depends on the form of the guarantee.

A method of verifying an affiliation performed by the above-described affiliation method comprises the following steps. A first step consists in reading the affiliation attestation 51 from the medium on which it is stored. Thereafter, a verification is performed by inspecting the associated guarantee.

When the guarantee is an affiliation seal 44, another step consists in reading the affiliation seal 44 from the medium(a) on which it is stored. During another step, the origin and the integrity of the affiliation attestation 51 are verified by means of the affiliation seal 44. This verification is performed by means of the authority cryptographic material 42.

If this verification is successful, the authenticity and the integrity of the affiliation attestation 51 are accepted and its content, comprising the tutor authorization 13, may be used in complete security.

In an implementation, the authority cryptographic material 42 comprises an authority public key PuKAu and an authority private key PrKAu, and the affiliation seal 44 was made using the authority private key PrKAu. Thus, the authority public key PuKAu corresponding to the authority private key PrKAu used for signing the affiliation attestation 51 is necessary and makes it possible to verify the affiliation seal 44.

Verifying the affiliation seal 44 by means of the authority public key PuKAu makes it possible to be sure of the origin of the affiliation attestation 51, that it was indeed created under the control of the authority 40, and that the integrity of its content has remained unchanged since it was issued. The content of the affiliation attestation 51, and in particular the content of the tutor authorization 13 can thus be trusted and can be used to exercise the rights of the tutor over the tutee.

It is assumed that the authority public key PuKAu is available to the affiliation verifier, and how the key is delivered does not come within the ambit of the invention. Such delivery is typically performed by a secure cryptographic transfer that guarantees its authenticity and its integrity. In order to avoid the constraints of such a transfer, in an alternative implementation, the authority public key PuKAu may be transmitted by means of the tutor or tutee electronic document 11 or 21 itself. Under such circumstances, the authority public PuKAu is previously signed by means of a key of very high level, itself previously shared between the authority 40 and the verifier.

The affiliation method and the affiliation verification method under the control of the authority cryptographic pair 42 ensure that the affiliation attestation 51 has a high level of legitimacy, since it is guaranteed by the authority 40.

When the content of the affiliation attestation 51 comprises a tutor attribute, e.g. such as tutor cryptographic material 12, e.g. the tutor public key PuKTu, of integrity that has been verified and of origin that is attested by the authority 40, it is possible to check the authenticity of the tutor 10 and, where applicable, of the tutor electronic document 11.

Depending on the implementation, the form of the inspection may change. When a tutor attribute is available, the authenticity of the tutor 10 can be inspected by giving the tutor the possibility, e.g. by dialog via a man/machine interface, to prove that the tutor knows the tutor attribute contained in the affiliation attestation 51.

This proof may be undertaken in various ways and this knowledge should be understood very broadly. Such knowledge may be knowledge properly speaking or possession. It may be direct or indirect. It may also be partial or complete.

Direct knowledge extends to knowledge that the holder holds directly. Thus, a holder knows directly his or her own name and date of birth. A holder naturally has a facial image that can be compared with an identity photo or indeed a biometric print for which the holder can give or give again a sample or an image. Direct knowledge also covers a password or a PIN number. Indirect knowledge or holding/possession extends to a visual or magnetic storage medium that can be presented during the inspection. It may thus be a bar code, a photo, or a graphical representation, a password, or cryptographic material.

The inspection is then successful if the holder claiming to be the tutor 10 is capable of responding to the request for proof concerning the tutor attribute by presenting directly or indirectly a response that is satisfactory in terms of the expected tutor attribute.

If the tutor attribute exists in a portion of the tutor cryptographic material 12 contained in the affiliation attestation 51, the authenticity of the tutor document 11 can be inspected by proving that the tutor document 11 holds at least a portion of the tutor cryptographic material 12.

If the tutor cryptographic material 12 comprises a tutor public key PuKTu and a tutor private key PrKTu, the authenticity of the tutor electronic document 11 is checked by proving that it holds the tutor private key PrKTu. This is typically done by challenge and response, as described above, using the tutor public key PuKTu, if that tutor public key PuKTu is available, e.g. contained in the affiliation attestation 51.

The tutor 10, with the accompanying tutor electronic document 11, is thus in a position to be able to prove holding the tutor private key PrKTu that corresponds to the tutor public key PuKTu as extracted from the affiliation attestation 51, thereby authenticating the tutor.

This may typically be done during an inspection formality if the tutor 10 and the tutor electronic document 11 are both present and involved in said formality.

When the content of the affiliation attestation 51 comprises a tutee attribute, such as for example tutee electronic material 22, such as for example the tutee public key PuKTe, of integrity that has been verified and of origin that is attested by the authority 40, it is possible to check the authenticity of the tutee 20 and, where applicable, of the tutee electronic document 21.

Depending on what is available, the inspection may be of some other form. When a tutee attribute is available, the authenticity of the tutee 20 can be inspected by giving the tutee the possibility, e.g. via a dialog using a man/machine interface, to prove that the tutee knows the tutee attribute contained in the affiliation attestation 51.

As for the tutor, this knowledge should be understood in very broad manner.

The inspection is then successful if the bearer claiming to be the tutee 20 is capable of responding to the request for proof concerning the tutee attribute by presenting directly or indirectly a response that is satisfactory in terms of the expected tutee attribute.

If the tutee attribute consists in a portion of the tutee cryptographic material 22 contained in the affiliation attestation 51, the authenticity of the tutee document 21 can be inspected by proving that the tutee document 21 holds at least a part of the tutee cryptographic material 22.

If the tutee cryptographic material 22 comprises a tutee public key PuKTe and a tutee private key PrKTe, the authenticity of the tutee electronic document 21 is checked by proving that it holds the tutee private key PrKTe. This is typically done by challenge and response, as described above, using the tutee public key PuKTe, if said tutee public key PuKTe is available, e.g. contained in the affiliation attestation 51.

The tutee 20, with the tutee electronic document 21, is thus in a position to be able to prove holding the tutee private key PrKTe that corresponds to the tutee public key PuKTe as extracted from the affiliation attestation 51, thereby authenticating the tutee.

This may typically be done during an inspection formality if the tutee 20 and the tutee electronic document 21 are both present and involved in said formality.

An illustrative example with a travel document system involving a minor child (tutee), authorized to cross a frontier solely in the company of a parent of the child (tutor). Under such circumstances, the tutee electronic document 21 and/or the tutor electronic document 11 stores an affiliation attestation 51 confirming that the tutor is the parent of the tutee. Inspection at the frontier of the electronic document 21 of the child alone would indicate that the child is not entitled to cross the frontier. The affiliation attestation 51 read by the inspector from the child's electronic document 21 and/or the parent's electronic document 11 establishes with certainty the parent-child relationship between the parent and the child, so the child can then be authorized to cross the frontier, since the child is accompanied by a parent. This may be conditional on verifying in the tutor authorization 13 that the parent is indeed authorized to allow the child to cross a frontier.

Affiliation is the essential first brick of the edifice. It can be used for various operations: emancipation and delegation.

An emancipation enables a tutor 10 to emancipate a tutee 20 by transferring at least one right directly to the tutee 20 with the tutee electronic document 21 if any as the medium, with this typically being to enable the tutee 20, even in the absence of the tutor, to perform a formality that can normally be performed only in the presence of the tutor 10. Under such circumstances, the actual presence of the tutor 10 is replaced by an emancipation attestation 61 specifying the rights that the tutor 10 authorizes to the tutee 20 together with limits in time and space.

For this purpose, an emancipation method comprises a step of creating an emancipation attestation 61. Such an emancipation attestation 61 comprises a tutee authorization 23 comprising the rights emancipated to the tutee 20 by the tutor 10.

Like the affiliation attestation 51, and in similar manner, the emancipation attestation 61 is advantageously stored so as to be subsequently retrievable in order to be inspected and used.

In order to be used and/or inspected, the emancipation attestation 61 needs an affiliation attestation 51 so as to define the link between the tutor 10 and the tutee 20. It is assumed that such an affiliation attestation 51 already exists and has already been stored. If not, it may be created and/or stored at the time of the emancipation.

Just like an affiliation attestation 51, a guarantee of integrity and authenticity can be produced that is associated with the emancipation attestation 61. This guarantee may be electronic.

In a preferred implementation, the electronic guarantee is an emancipation seal 16 produced by electronically signing the emancipation attestation 61 by means of tutor cryptographic material 12 associated with the tutor 10.

After such an emancipation seal 16 has been produced by electronic signing, the emancipation seal 16 may advantageously be stored. It may be stored in any location, together with or separately from the emancipation attestation 61. In a particular implementation, it may be incorporated in the emancipation attestation 61. The only constraint is that said emancipation seal 16 can be reread when necessary, e.g. in order to perform a method of verifying the emancipation attestation 61.

According to a characteristic, the emancipation attestation 61 also comprises an attribute of the tutor and/or an attribute of the tutee. The term “attribute” is used herein to mean an element, recording, data, possession, etc., relating to or associated with the person of the tutor and/or the tutee as the case may be, and serving to establish a link with that person.

In an implementation, the tutor 10 is associated with tutor cryptographic material 12. Under such circumstances, the tutor attribute may be composed by at least a portion of the tutor cryptographic material 12. Likewise, the tutee 20 may be associated with tutee cryptographic material 22. Under such circumstances, the tutee attribute comprises at least a portion of the tutee cryptographic material 22.

As mentioned above, the emancipation attestation 61 and any emancipation seal 16 can be stored. This storage may be performed on any medium, so long as it enables it to be reread for a subsequent use. Thus, this storage may be performed on a tutor document 11 associated with the tutor 10, on a tutee document 21 associated with the tutee 20, and more generally on any mass storage medium or indeed on such a mass storage medium that is accessible via a communication network, referred to below as a network storage medium. Each of the stored elements may be stored in full on a single one of these media, or indeed it may be divided into a plurality of portions, each portion being stored on a respective storage medium selected from among the above media.

In a preferred implementation, the tutor 10 is associated with a tutor electronic document 11 and the tutee 20 is associated with a tutee electronic document 21. Under such circumstances, and as shown in FIG. 2, an emancipation operation is performed and implemented electronically by an emancipation method. As in the above-described general situation, the emancipation method comprises a first step of creating an emancipation attestation 61 that comprises a tutee authorization 23. Like the tutor authorization 13, the tutee authorization 23 is a file comprising the rights emancipated to the tutee 20 by the tutor 10. It defines what the tutee 20 can do in the absence of the tutor 10 by way of delegation compared with what the tutee 20 could otherwise do only in the presence of the tutor 10. The tutee authorization 23 further comprises any conditions on exercising these rights and any limits, both in space and in time, on these rights.

Logically, the rights emancipated in this way to the tutee 20 cannot go beyond the rights actually available to the tutor 10. Thus, the tutee authorization 23 is advantageously a subset of the tutor authorization 13. This necessary relationship can be verified when creating the tutee authorization 23 during the emancipation method. Alternatively, this relationship may be verified at any time by one of the verification methods, e.g. prior to exercising one of the rights.

During a second step, at least a portion or digest of the content of the emancipation attestation 61 is signed electronically by means of the tutor private key PrKTu. This produces an emancipation seal 16 guaranteeing the origin (the tutor 10) and the integrity of the emancipation attestation 61.

During a third step, the emancipation attestation 61 and the emancipation seal 16 are stored, together or separately, advantageously in the tutee electronic document 21. It is also possible for them to be stored in the tutor electronic document 11 (or in some other electronic document), but in practice that is of little use since the purpose of an emancipation is to enable the tutee 20, together with the tutee electronic document 21 if any, to perform a formality alone, in the absence of the tutor 10. In this situation, using a network medium for storage is advantageous, insofar as said network is available during the utilization, verification, or working of the emancipation attestation 61.

In order to enable the emancipation attestation 61 and the emancipation seal 16 to be verified, a copy of the affiliation attestation 51 and of the associated affiliation seal 44 as produced by the above-described affiliation method is needed. Thus, if they are not already present in the tutee electronic document 21, the affiliation attestation 51 and the affiliation seal 44 are advantageously stored in the tutee electronic document 21. Also advantageously, any alternative storage medium can be used in such circumstances providing it is accessible when needed. Since it generally accompanies the tutee 20, the tutee electronic document 21 is a medium that is advantageously available and present.

Emancipation may be likened to a right being delegated directly from the tutor 10 to the tutee 20.

FIG. 2 shows an implementation of the emancipation method. An emancipation attestation 61 is created comprising a tutee authorization 23 containing the rights that are emancipated to the tutee 20. The tutee electronic document 21 optionally (as indicated by a dashed line) supplies (as indicated by a thin arrow) the tutee public key PuKTe. The tutor electronic document 11 signs (as indicated by a thick arrow) the emancipation attestation 61 by means of the tutor private key PrKTu and produces an emancipation seal 16. The emancipation attestation 61 and the emancipation seal 16 are stored (as indicated by a broad white arrow) in the tutee electronic document 21. The affiliation attestation 51 and the affiliation seal 44 as made during the affiliation method are also stored in the tutee electronic document 21.

Via the tutor electronic document 11, the tutor 10 acts during the emancipation method as an authority. Nevertheless, the tutor's level of security and legitimacy are conferred on the tutor by the authority 40. Thus, the presence of the affiliation attestation 51 in addition to the emancipation attestation 61 is required. There is thus a stack of attestations 51, 61 that are present, which complement one another and they confer security stemming from the highest level: the authority 40.

Unlike the affiliation, which needs to be signed by the authority 40 and can therefore be made only in the premises of the authority and using the heavyweight cryptographic infrastructure 41 of the authority 40, emancipation makes use of a signature by the tutor 10. Creating an emancipation attestation 61 requires the tutor electronic document 11 to perform the step of signing by means of the tutor private key PrKTu. It also requires the tutee electronic document 21 for the step of storing the emancipation attestation 61 and the emancipation seal 16, and where necessary for the step of copying/storing the affiliation attestation 51 and the affiliation seal 44.

Nevertheless, such electronic documents 11, 21 are portable and independent. Thus, the tutor electronic document 11 can perform the signing step independently. As a result, and in highly advantageous manner, the emancipation method can be performed by means of very lightweight infrastructure. Thus, by way of example, a person having an electronic document reader, which may be: an SD card reader, a USB reader, a microcircuit card reader, etc., available on a personal computer or the equivalent together with a suitable simple and standard software application can perform the emancipation method, e.g. from home, providing that person has the tutor electronic document 11 and the tutee electronic document 21. There is thus no need for a connection to a secure network, nor for the intervention of a trusted third party nor of an organization authorized by the authority 40.

For another function, it may be useful to have the tutee public key PuKTe (and the tutor public key PuKTu). Thus, optionally, and in particular if not comprised in the affiliation attestation 51, the emancipation attestation 61 may also comprise the tutee public key PuKTe.

In exchange for the simplicity of the means for implementing the emancipation method, signing by the tutor 10 becomes an important step in the emancipation method and makes it possible to transmit rights developed by the authority 40 itself on the tutor 10. Thus, it is appropriate to ensure that the signing step is properly performed, preferably in the presence of, and at least with the agreement of, the tutor 10 and not only in the presence of the tutor electronic document 11, which might be accessible to the tutee 20, for example. Thus, according to an advantageous optional characteristic, the electronic signature in the emancipation method is conditional on authenticating the bearer of the tutor electronic document 11. The purpose of this authentication is to ensure the presence, and above all the consent, of the tutor 10 to the emancipation, both in principle and in detail. This authentication of the tutor electronic document 11 may be performed by any means. Thus, for example, it may be necessary to input a secret code associated with the tutor electronic document 11, e.g. of the PIN code type. As an alternative, or in addition, a biometric identification check may also serve to authenticate the tutor.

A priori, there is no need to obtain the consent of the tutee 20 for an emancipation to the tutee's advantage. Furthermore, depending on circumstances, the tutee 20 is not necessarily in a position to give such consent. Nevertheless, it is easy to comprise a step of obtaining such consent in an emancipation method, e.g. by means of a step of authenticating the tutee 20 by verifying a PIN code and/or by means of a biometric test.

Once an emancipation has been created, it can be verified, typically prior to performing a formality that requires a right that the tutee 20 normally does not possess but may be entitled to exercise by emancipation. Prior to any use of an emancipated right, it is preferable to verify the emancipation. A method of verifying an emancipation depends on the form and the content of the emancipation.

An emancipation that comprises an optionally electronic guarantee can be verified. The way in which it is verified depends on the form of the guarantee.

A method of verifying an emancipation, itself made by the above-described emancipation method, comprises the following steps. A first step consists in reading the affiliation attestation 51 from the medium on which it is stored. During a second step, the origin and the integrity of the affiliation attestation 51 are verified by checking the associated electronic guarantee. A first step consists in reading the emancipation attestation 61 from the medium on which it is stored. During a fourth step, the origin and the integrity of the emancipation attestation 61 are verified by checking the associated electronic guarantee.

When the affiliation guarantee is an affiliation seal 44, another step consists in reading the affiliation seal 44 from the medium(a) on which it is stored. As above in the affiliation method, during another step, the origin and the integrity of the affiliation attestation 51 are verified by means of the affiliation seal 44. This verification is performed by means of the authority cryptographic material 42.

When the emancipation guarantee is an emancipation seal 16, another step consists in reading the emancipation seal 16 from the medium(a) on which it is stored. During another step, the origin and the integrity of the emancipation attestation 61 are verified by means of the emancipation seal 16. This verification is performed by means of the tutor cryptographic material 12.

If both of these verifications are positive, the authenticity and the integrity of the emancipation attestation 61 are accepted and its content, comprised in the tutee authorization 23, can be exploited with confidence.

In an implementation, the authority cryptographic material 42 comprises an authority public key PuKAu and an authority private key PrKAu, and the affiliation seal 44 is made using the authority private key PrKAu. Thus, the authority public key PuKAu corresponding to the authority private key PrKAu used for signing the affiliation attestation 51 is necessary and serves to verify the affiliation seal 44. These first two steps substantially reproduce the steps of the method of verifying affiliation, since the legitimacy of the emancipation is certified by the affiliation attestation 51. This step also makes it possible to extract the tutor public key PuKTu from the affiliation attestation 51 with assurance concerning its origin and its integrity.

In another implementation, the tutor cryptographic material 12 comprises a tutor public key PuKTu and a tutor private key PrKTu, and the emancipation seal 16 is made using the tutor private key PrKTu. Thus, the origin and the integrity of the emancipation attestation 61 are verified by means of the emancipation seal 16. For this purpose, the tutor public key PuKTu corresponding to the tutor private key PrKTu that was used for signing the emancipation attestation 61 is necessary, and makes it possible to verify the emancipation seal 16.

Verifying the emancipation seal 16 by means of the tutor public key PuKTu serves to provide assurance concerning the origin of the emancipation attestation 61, which was indeed created under the control of the tutor 10, and also concerning the integrity of its content, which has not changed since it was issued. The content of the emancipation attestation 61, and in particular the content of the tutee authorization 23 can thus be trusted and therefrom used to apply the rights that have been emancipated to the tutee 20.

The tutor public key PuKTu is already available to the emancipation verifier, since the tutor public key PuKTu is supplied by the affiliation attestation 51, which is certified by the authority 40, and this key has previously been extracted.

The emancipation method and the emancipation verification method under the checking provided by the tutor cryptographic pair 12 ensure a high level of legitimacy to the emancipation attestation 61 since it is guaranteed by the tutor 10, with the legitimacy of the tutor 10 itself being guaranteed by the authority 40 using checking by means of the authority cryptographic pair 42.

As above, when a tutor attribute is available in the content of the affiliation attestation 51, e.g. tutor cryptographic material 12, such as for example the tutor public key PuKTu, it is optionally possible to check the authenticity of the tutor 10 and thus, where applicable, of the tutor electronic document 11. The term “optionally” refers to the situation in which the tutor 10 and/or the tutor electronic document 11 are actually present during the formality. Specifically, the purpose of the emancipation may be to enable the tutee 20 to perform a formality alone.

Depending on the implementation, the inspection may change form. When a tutor attribute is available, the authenticity of the tutor 10 can be checked by giving the tutor the possibility of proving that he or she knows the tutor attribute contained in the affiliation attestation 51, e.g. by dialog using a man/machine interface.

This proof may be obtained in various ways and this knowledge should be understood very broadly.

The inspection is then validated if the bearer who claims to be the tutor 10 is capable of responding to the request for proof concerning the tutor attribute by presenting directly or indirectly a response that is satisfactory in terms of the expected tutor attribute.

If the tutor attribute consists in a portion of the tutor cryptographic material 12, the authenticity of the tutor 10 and of the tutor document 11 can be checked by proving that the tutor document 11 holds at least a portion of the tutor cryptographic material 12.

If the tutor cryptographic material 12 comprises the tutor public key PuKTu and the tutor private key PrKTu, then the authenticity of the tutor 10 and of the tutor electronic document 11 can be checked by proving that it holds the tutor private key PrKTu. This is typically performed by challenge and response, as described above, using the tutor public key PuKTu, assuming said tutor public key PuKTu is available, e.g. contained in the affiliation attestation 51 or in the emancipation attestation 61.

The tutor 10 together with the tutor electronic document 11 is thus in a position to prove possession of the tutor private key PrKTu corresponding to the tutor public key PuKTu as extracted from the affiliation attestation 51, thereby authenticating the tutor.

In analogous manner, depending on the implementation, if a tutee attribute, e.g. tutee cryptographic material 22, such as for example the tutee public key PuKTe is available, e.g. because it is contained in the affiliation attestation 51 and/or in the emancipation attestation 61 and/or on any medium that is accessible during the verification, it is possible to proceed in analogous manner to verify the authenticity of the tutee 20, and thus of the tutee electronic document 21, if any.

Depending on the implementation, the inspection may change form. When a tutee attribute is available, the authenticity of the tutee 20 can be inspected by giving the tutee the possibility of proving that he or she knows the tutee attribute, e.g. by means of a man/machine interface.

This proof may be obtained in various ways and this knowledge should be understood very broadly.

The inspection is then validated if the bearer claiming to be the tutee 20 is capable of responding to the request for proof concerning the tutee attribute by presenting directly or indirectly a response that is satisfactory in terms of the expected tutee attribute.

If the tutee attribute consists in a portion of the tutee cryptographic material 22, the authenticity of the tutee 20 and of the tutee document 21 can be checked by proving that the tutee document 21 holds at least a portion of the tutee cryptographic material 22.

If the tutee cryptographic material 22 comprises a tutee public key PuKTe and a tutee private key PrKTe, the authenticity of the tutee 20 and of the tutee electronic document 21 is checked by proving that the tutee holds the tutee private key PrKTe. This is typically performed by challenge and response, as described above, with the tutee public key PuKTe, if the tutee public key PuKTe is available, e.g. contained in the affiliation attestation 51 or in the emancipation attestation 61.

The tutee 20 together with the tutee electronic document 21 is thus in a position to prove that the tutee holds the tutee private key PrKTe corresponding to the tutee public key PuKTe extracted from the affiliation attestation 51 or from the emancipation attestation 61, thereby authenticating the tutee.

An illustrative example with a travel document system involves a minor child (tutee) who receives exit authorization by emancipation. This authorization allows the child to cross a frontier even in the absence of either parent (tutor). The tutee electronic document 21 stores an affiliation attestation 51 associated with the parent who made the emancipation and an emancipation attestation 61 mentioning in the tutee authorization 23 that the child is authorized to travel alone. Inspection at the frontier of the electronic document 21 of the child alone would indicate that the child is not entitled to cross the frontier. The tutee authorization 23 establishes the right of the child to travel alone. The emancipation attestation 61 read by the controller from the child's electronic document 21 makes it possible to determine that a parent has made an emancipation, and the affiliation attestation 51 proves that the parent is authorized by the authority 40 to emancipate this right.

The invention also relates to an electronic document comprising an affiliation attestation 51 and/or an affiliation seal 44 in accordance with any of the above implementations, and/or an emancipation attestation 61 and/or an emancipation seal 16 in accordance with any of the above implementations.

Such an electronic document may also comprise a tutor attribute, or a tutee attribute, as described above, in order to form a tutor electronic document or a tutee electronic document, as the case may be.

1. An affiliation method identifying a tutoring relationship between a tutor and a tutee, the affiliation method comprising:
creating an affiliation attestation comprising:
a tutor authorization comprising the rights over the tutee that are allocated to the tutor; and
storing the affiliation attestation.

2. The affiliation method according to claim 1, further comprising:
producing an electronic guarantee of the integrity and the authenticity of the affiliation attestation.

3. The affiliation method according to claim 2, wherein the electronic guarantee is an affiliation seal produced by electronically signing the affiliation attestation by means of authority cryptographic material associated with an authority, and wherein the method further comprises:
storing the affiliation seal.

4. The affiliation method according to claim 3, wherein the authority cryptographic material comprises an authority public key and an authority private key, and wherein the portion of the authority cryptographic material used for producing the affiliation seal comprises the authority private key.

5. The affiliation method according to claim 1, wherein the affiliation attestation further comprises a tutor attribute or a tutee attribute.

6. The affiliation method according to claim 5, wherein the tutor is associated with tutor cryptographic material, and the tutor attribute comprises at least a portion of the tutor cryptographic material, or the tutee is associated with tutee cryptographic material, and the tutee attribute comprises at least a portion of the tutee cryptographic material.

7. The affiliation method according to claim 6, wherein the tutor cryptographic material comprises a tutor public key and a tutor private key, and the portion of the tutor cryptographic material comprised in the tutor attribute comprises the tutor public key, or the tutee cryptographic material comprises the tutee public key and a tutee private key, and the portion of the tutee cryptographic material comprised in the tutee attribute comprises the tutee public key.

8. The affiliation method according to claim 1, wherein storing the affiliation attestation is performed on at least one of a group consisting of:
a tutor document associated with the tutor;
a tutee document associated with the tutee;
a mass storage medium;
a network storage medium; or
distributed over a plurality of the above media.

9. The affiliation method according to claim 8, wherein the tutor document and the tutee document are electronic documents produced by an authority, wherein the tutor document stores tutor cryptographic material, and wherein the tutee electronic document stores tutee cryptographic material.

10. A verification method for verifying an affiliation made by the affiliation method according to claim 2, the verification method comprising:
reading the affiliation attestation;
optionally checking the origin and the integrity of the affiliation attestation by verifying the electronic guarantee; and
making use of the tutor authorization.

11. The verification method according to claim 10, wherein the checking of the origin and the integrity of the affiliation attestation further comprises:
reading an affiliation seal; and
checking the affiliation seal by means of at least a portion of authority cryptographic material associated with an authority.

12. The verification method according to claim 11, wherein the authority cryptographic material comprises an authority public key and an authority private key, and wherein the portion of the authority cryptographic material used for checking the affiliation seal comprises the authority public key.

13. The verification method according to claim 10, further comprising at least one of:
if a tutor attribute is comprised in the affiliation attestation, optionally checking the authenticity of the tutor by proving that the tutor knows the tutor attribute comprised in the affiliation attestation; and
if a tutee attribute is comprised in the affiliation attestation, optionally checking the authenticity of the tutee by proving that the tutee knows the tutee attribute.

14. The verification method according to claim 10, further comprising at least one of:
if a portion of tutor cryptographic material is comprised in the affiliation attestation, optionally checking the authenticity of a tutor document by proving that the tutor document holds at least a portion of the tutor cryptographic material; and
if a portion of tutee cryptographic material is comprised in the affiliation attestation, optionally checking the authenticity of a tutee document by proving that the tutee document holds at least a portion of the tutee cryptographic material.

15. The verification method according to claim 10, further comprising at least one of:
if tutor cryptographic material comprises a tutor public key and a tutor private key, optionally checking the authenticity of a tutor electronic document by proving that the tutor document holds the tutor private key by using a challenge and response with the tutor public key if said tutor public key is comprised in the affiliation attestation; and
if tutee cryptographic material comprises a tutee public key and a tutee private key, optionally checking the authenticity of a tutee electronic document by proving that the tutee document holds the tutee private key by using a challenge and response with the tutee public key if said tutee public key is comprised in the affiliation attestation.

16. An emancipation method enabling a tutor to emancipate a tutee, the emancipation method comprising:
creating an emancipation attestation comprising:
a tutee authorization comprising the rights emancipated to the tutee by the tutor;
storing the emancipation attestation; and
if an affiliation attestation is not already present, storing the affiliation attestation produced by the affiliation method according to claim 1.

17. The emancipation method according to claim 16, further comprising:
producing an electronic guarantee of the integrity and the authenticity of the emancipation attestation.

18. The emancipation method according to claim 17, wherein the electronic guarantee is an emancipation seal produced by electronically signing the emancipation attestation by means of tutor cryptographic material, and wherein the method further comprises:
storing the emancipation seal.

19. The emancipation method according to claim 16, wherein the emancipation attestation further comprises a tutor attribute or a tutee attribute.

20. The emancipation method according to claim 16, wherein the tutor is associated with tutor cryptographic material, and the tutor attribute comprises at least a portion of the tutor cryptographic material, or the tutee is associated with tutee cryptographic material, and the tutee attribute comprises at least a portion of the tutee cryptographic material.

21. The emancipation method according to claim 20, wherein the tutor cryptographic material comprises a tutor public key and a tutor private key, and the portion of the tutor cryptographic material used for producing an emancipation seal comprises the tutor private key.

22. The emancipation method according to claim 20, wherein the tutor cryptographic material comprises a tutor public key and a tutor private key, and the portion of the tutor cryptographic material comprised in the tutor attribute comprises the tutor public key, or the tutee cryptographic material comprises a tutee public key and the tutee private key, and the portion of the tutee cryptographic material comprised in the tutee attribute comprises the tutee public key.

23. The emancipation method according to claim 18, wherein the electronic signing step is conditional on supplying a tutor document and on authenticating the bearer of the tutor document, by means of a PIN code associated with the tutor document, or a biometric identification, or by proving that the bearer knows a tutor attribute comprised in the affiliation attestation or in the emancipation attestation.

24. The emancipation method according to claim 16, wherein storing the emancipation attestation is performed on at least one of a group consisting of:
a tutor document associated with the tutor;
a tutee document associated with the tutee;
a mass storage medium;
a network storage medium; or
istributed over a plurality of the above media.

25. The emancipation method according to claim 24, wherein the tutor document and the tutee document are electronic documents produced by an authority, wherein the tutor electronic document stores tutor cryptographic material, and wherein the tutee electronic document stores tutee cryptographic material.

26. A verification method for verifying an emancipation made by the emancipation method according to claim 16, the verification method comprising:
reading the affiliation attestation;
optionally checking the origin and the integrity of the affiliation attestation by verifying an associated electronic guarantee;
reading the emancipation attestation;
optionally checking the origin and the integrity of the emancipation attestation by verifying an associated electronic guarantee; and
making use of the tutee authorization.

27. The verification method according to claim 26, wherein checking the origin and the integrity of the affiliation attestation further comprises:
reading an affiliation seal;
checking the affiliation seal by means of at least a portion of authority cryptographic material, and
wherein checking the origin and the integrity of the emancipation attestation further comprises:
extracting at least a portion of tutor cryptographic material from the affiliation attestation;
reading the emancipation attestation;
reading an emancipation seal; and
checking the emancipation seal by means of at least a portion of the tutor cryptographic material.

28. The verification method according to claim 27, wherein the authority cryptographic material comprises an authority public key and an authority private key, and wherein the portion of the authority cryptographic material used for checking the affiliation seal comprises the authority public key, and wherein the tutor cryptographic material comprises a tutor public key and a tutor private key, and wherein the portion of the tutor cryptographic material used for checking the emancipation seal comprises the tutor public key.

29. The verification method according to claim 26, further comprising:
if a tutee attribute is comprised in the affiliation attestation or in the emancipation attestation, optionally checking the authenticity of the tutee by proving that the tutee knows said tutee attribute.

30. The verification method according to claim 26, further comprising:
if a portion of tutee cryptographic material is comprised in the affiliation attestation or in the emancipation attestation, optionally controlling the authenticity of a tutee document by proving that the tutee document holds at least a portion of the tutee cryptographic material.

31. The verification method according to claim 26, further comprising:
if tutee cryptographic material comprises a tutee public key and a tutee private key, and if said tutee public key is comprised in the affiliation attestation or in the emancipation attestation, optionally checking the authenticity of a tutee electronic document by proving that the tutee electronic document holds the tutee private key, by means of a challenge and response with said tutee public key.

32. An electronic document comprising an affiliation attestation in accordance with claim 1.

33. An electronic document comprising a tutor attribute or a tutee attribute in accordance with claim 5, in order to form respectively a tutor electronic document or a tutee electronic document.

34. An electronic document comprising an electronic guarantee in accordance with claim 2.

35. An electronic document comprising an emancipation attestation in accordance with claim 16.

36. An electronic document comprising an electronic guarantee in accordance with claim 17.
